(19) United States
(12) Patent Application Publication
(10) Pub. No.: US 2008/0023078 A1
(43) Pub. Date: Jan. 31, 2008

(54) Constant Flow Regulator Device

(75) Inventor: Svante Bahrton, San Francisco, CA (US)

Correspondence Address: MORRISON & FOERSTER LLP, 425 MARKET STREET, SAN FRANCISCO, CA, 94105-2482, US

(73) Assignee: Aerocrine AB, Solna (SE)

(21) Appl. No.: 11/632,253

(22) PCT Filed: Jan. 24, 2006
(86) PCT No.: PCT/SE06/00109

§ 371 Date: Jan. 10, 2007

(30) Foreign Application Priority Data
Jan. 25, 2005 (SE) 0500185-4

(51) Int. Cl. F16K 17/34

(52) U.S. Cl. 137/484.2

(57) ABSTRACT

A constant flow regulator device for maintaining a constant flow of fluid when a variable fluid pressure is applied, comprising an inlet duct (506) for incoming fluid, a housing (500), and a movable partition (502) facing the inlet duct and being subjected to an elastic force. A fluid passage (510) of variable cross section area is formed between the inlet duct and the movable partition. The housing and movable partition form an inner compartment (504) in fluid communication with the inlet duct for establishing a fluid pressure inside the inner compartment approximately equal to the fluid pressure in the inlet duct. The size of the movable partition is significantly greater than the size of the inlet duct such that, in use, the partition is moved towards the inlet duct against the elastic force when the fluid pressure in the inlet duct increases to reduce said fluid passage cross section area, and vice versa, thereby maintaining constant fluid flow.

The present invention relates generally to a constant flow regulator device for maintaining a constant flow of fluid when a variable fluid pressure is applied, preferably a flow of gas or gas mixture. The fluid flow may be measured in ml/s. In particular, the inventive constant flow regulator device is configured to maintain the fluid flow substantially constant regardless of the applied fluid pressure, at least within a certain operating range.

### BACKGROUND ART

Previously known fluid flow regulator devices are relatively complex devices having several different interacting parts, such as springs, diaphragms, valves and valve seats. These devices are relatively costly to produce, both due to the many parts required which need to be manufactured with high precision, and also due to high assembly costs. Other problems with previously known devices are related to reliability and endurance.

U.S. Pat. No. 3,463,182 discloses a constant pressure fluid regulator where a fluid flows through an orifice 50 in a deformable diaphragm 42. When a fluid is applied under increased pressure to an inlet tube 22, the diaphragm is deformed so as to establish an orifice 51 between the diaphragm and a shoulder 24 on the inlet tube. The fluid can then pass through inlet tube 22, orifice 51 and orifice 50 to escape through an opening 30. However, this regulator is designed for creating a constant fluid pressure and cannot be used for creating a constant fluid flow.

### SUMMARY OF THE INVENTION

It is an object of the present invention to address the problems above and to provide a simple yet reliable and accurate constant flow regulator device.

The present invention is based on a simple mechanism for keeping a fluid flow constant through the constant flow regulator device. The basic idea is to use an expandable inner compartment in fluid communication with an inlet duct or opening for incoming fluid. The inner compartment is delimited by a movable partition facing the inlet duct and being subjected to an elastic force. The size of the movable partition is significantly greater than the size of the inlet duct such that the resulting pressure force from the fluid on the movable partition is greater on the inside than on the outside, tending to move the partition towards the inlet duct.

Due to the size difference mentioned above, the inner compartment is thus expanded when the pressure in the inlet duct and in the inner compartment increases to move the partition towards the inlet duct against the elastic force. As a result, a passage area between the partition and the inlet duct for the fluid through the device is reduced as the partition is moved due to the increased pressure. In this way, the fluid flow through the device is kept substantially constant even though the fluid pressure rises. When the pressure applied to the fluid at the inlet duct decreases, the inner compartment is contracted as the partition is moved back by the elastic force due to a resulting decreased fluid pressure in the inner compartment, thereby increasing the passage area to maintain the flow of fluid constant through the device.

The elastic force may be obtained by using a resilient material in the movable partition such as rubber or other polymer, or in at least a part thereof. Preferably, the characteristics of the elastic force acting on the partition have been selected such that the passage area is changed optimally responsive to changes of the fluid pressure. Optimal elasticity characteristics of a resilient partition may be obtained by selecting a suitable material and/or thickness of the resilient part(s). A satisfactory result may be obtained if the characteristics of the elastic force are selected such that the movement of the partition becomes proportional to the square of the change of the incoming fluid pressure. For example, if the incoming fluid pressure is increased four times, the fluid passage between the partition and the inlet duct will then be reduced to half the size.

A suitable outlet opening for fluid leaving the constant flow regulator device may be provided, but the present invention is not limited in this respect. Further, the fluid communication between the inlet duct and the inner compartment may be obtained by means of an aperture in the partition located in a high pressure area in the vicinity of the incoming fluid from the inlet duct, or by means of a separate fluid connection conduit between the inlet duct and the inner compartment.

It should be noted that the inner compartment does not need to have a volume when the pressure of the inlet medium is low, but may expand and thus develop a volume when the pressure in the inlet medium increases.

A constant flow regulator device according to one aspect of the present invention is claimed in claim 1. A method of keeping a flow of fluid constant according to another aspect of the present invention is claimed in claim 13. Preferred embodiments of the present invention are defined in the depending claims.

Since the inventive constant flow regulator device can be produced merely by means of a housing and an expandable inner compartment having a movable partition, it is simple to manufacture. Moreover, the components making up the device are not necessarily expensive, resulting in an altogether inexpensive device. Nevertheless, the device according to the invention can be made reliable and has a high endurance due to the use of few and ordinary components.

In the preferred embodiments, at least a part of the movable partition comprises a diaphragm. For example, the diaphragm may be flat or dome-shaped.

### SHORT DESCRIPTION OF THE DRAWINGS

Preferred embodiments of the present invention will now be described below by means of examples illustrated in the appended drawings, in which:

FIG. 1 illustrates a sectional view of a constant flow regulator device according to a first embodiment of the present invention.

FIG. 2 illustrates a sectional view of a constant flow regulator device according to a second embodiment of the present invention.

FIG. 3 illustrates a front view of the first embodiment of the present invention.

FIG. 4 illustrates a sectional view of a constant flow regulator device according to a third embodiment of the present invention.

FIG. 5 illustrates a sectional view of a constant flow regulator device according to a fourth embodiment of the present invention.

FIG. 6 illustrates a sectional view of a constant flow regulator device according to a fifth embodiment of the present invention.

FIG. 7 illustrates a front view of an inlet duct of a constant flow regulator device according to a sixth embodiment of the present invention.

FIG. 8 illustrates a sectional view of a constant flow regulator device according to a seventh embodiment of the present invention.

FIG. 9 illustrates a sectional view of a constant flow regulator device according to an eighth embodiment of the present invention.

### DETAILED DESCRIPTION OF PREFERRED EMBODIMENTS

As mentioned above, an expandable inner compartment can be used, which is expanded when the inlet pressure increases to reduce the passage area for the fluid flow passing through the device. On the other hand, when the inlet pressure decreases, the inner compartment is contracted and thus the passage area is enlarged, thereby maintaining a constant fluid flow.

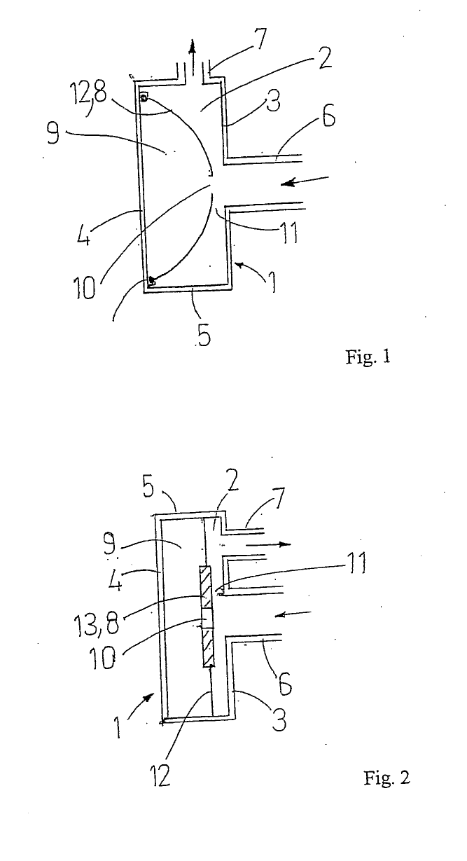

In FIG. 1, a constant flow regulator device according to a first embodiment is illustrated. The device comprises a housing 1 making up a chamber 2 having a first wall 3 and a second wall 4 arranged opposite each other. In the first embodiment, a side wall 5 joins the first and second walls 3, 4 together. However, the provision of a side wall is not always needed, see for example the third embodiment shown in FIG. 4 where the first and the second walls 3, 4 are joined together in order to make up a housing 1 with a chamber 2.

An incoming fluid flow, i.e. the flow to be kept constant, enters through an inlet duct or opening 6, e.g. provided with a connection piece, in the first wall 3. The outgoing fluid flow leaves the device through at least one outlet opening 7, which may likewise be provided with a connection piece. In this embodiment, the outlet opening 7 is arranged in the side wall 5, but it may also be arranged in the first wall 3, as in the second and third embodiments shown in FIG. 2 and 4, respectively. It is also conceivable to have an outlet opening in the second wall depending on the space available outside an inner compartment 9, to be described below.

According to the first embodiment shown in FIG. 1, an inner compartment 9 is formed by arranging a movable partition 8 inside the chamber 2, which together with the second wall 4 makes up the inner compartment. The partition 8 is made of a resilient material such as rubber or other polymer. The inner compartment, preferably at the movable partition 8, is provided with an aperture 10 preferably somewhere in a central part of the movable partition 8, for fluid communication between the inlet duct and the inner compartment. The inlet duct 6 is also arranged somewhere in the central part of the first wall 3, and thus roughly opposite the aperture 10 in the movable partition 8. However, the inlet duct 6 and the aperture 10 do not need to be aligned, as long as the aperture 10 is located in the vicinity of a high pressure area of the incoming fluid at the inlet duct 6. The inner compartment 9 may not need to have any volume when the pressure of the inlet medium is low, but may expand and thus display a volume when the pressure in the inlet medium increases.

As mentioned above, it is not necessary that the first, inlet wall 3 and the inner compartment 9 part of the device are connected. They may for example only be arranged in relatively fixed positions adjacent each other.

In use, the movable partition 8 is subjected to an elastic force basically acting in a direction away from the inlet duct, whereas the fluid pressure in the inner compartment acts to move the partition 8 in a direction towards the inlet duct, i.e. opposite and against the elastic force. Preferably, the elastic force is obtained by using a resilient material in the partition, as shown in the first embodiment. Depending on the pressure of the incoming fluid flow, the inner compartment 9 will thus be more or less “inflated”, i.e. have a variable inner volume, whereby the movable partition will move towards or away from, respectively, the first wall 3 when the incoming fluid pressure is changed.

Preferably, the characteristics of the elasticity of the resilient material in the partition have been selected such that said passage area is changed optimally responsive to changes of said variable fluid pressure, e.g. such that the partition movement change is proportional to the square of the pressure change. Thereby a balance is achieved between a force from the incoming fluid pressure in the inlet duct plus said elastic force, and a force in the opposite direction from the fluid pressure inside the inner compartment.

Between the movable partition 8 and the first wall 3 in the vicinity of the inlet duct 6 and the aperture 10, a fluid passage 11 is present having a cross sectional area which depends on the distance between the movable partition 8 and the first wall 3. When the movable partition 8 moves towards or away from the first wall 3, the cross sectional area of the fluid passage 11 will decrease or increase, respectively, i.e. the passage 11 between the movable partition 8 and the first wall 3 will be reduced or enlarged, respectively. In this way, a change of fluid pressure is compensated by a change of the fluid passage size so that the fluid flow through this passage 11 and further out of the outlet opening/-s 7 will be kept substantially constant. The fluid flow can be measured in ml/s.

Preferably, the cross sectional area of the outlet opening/-s 7 is substantially greater than the cross sectional area of the fluid passage 11, in order not to disturb the outlet flow so that all of the pressure drop occurs at the passage 11.

By choosing certain measurements of the inlet duct or opening 6, the outlet opening/-s 7, the aperture 10, the “expandability” of the inner compartment 9 as determined by the characteristics of the elastic force, and the distance between the movable partition 8 and the inlet duct 6, it is possible to design a device which operates to provide a constant fluid flow through the device in a desired range or interval of the incoming fluid pressure. The skilled person in the art may obtain a constant flow regulator device providing a constant fluid flow in the desired pressure interval, by performing tests for these measurements.

The inner compartment 9 may also be delimited by the second wall 4, the side wall 5 and the movable partition 8, see for example the embodiment shown in FIG. 2.

Preferably, at least a part of the movable partition 8 may be made of a resilient diaphragm 12 providing the elastic force. In the first embodiment shown in FIG. 1 the movable partition 8 is a dome-shaped diaphragm 12, and in the third embodiment shown in FIG. 4 the movable partition 8 is a substantially flat diaphragm 12. In the second embodiment shown in FIG. 2 the movable partition 8 comprises a plate 13 of a rigid material, such as a plastic or a metal, in which the aperture 10 is formed, and a partial diaphragm 12, such as a rubber ring. The movable partition 8 should be fitted within the housing 1 in a fluid tight manner. The plate 13 and also the housing 1 are preferably circular in shape, but may of course have other configurations.

As mentioned above, the fluid flow regulation is based on the achievement of a balance between a force from the inlet pressure plus a force from the elasticity of the diaphragm (in the case a diaphragm is used at least partially) and a force, in the opposite direction, from the fluid pressure inside the inner compartment.

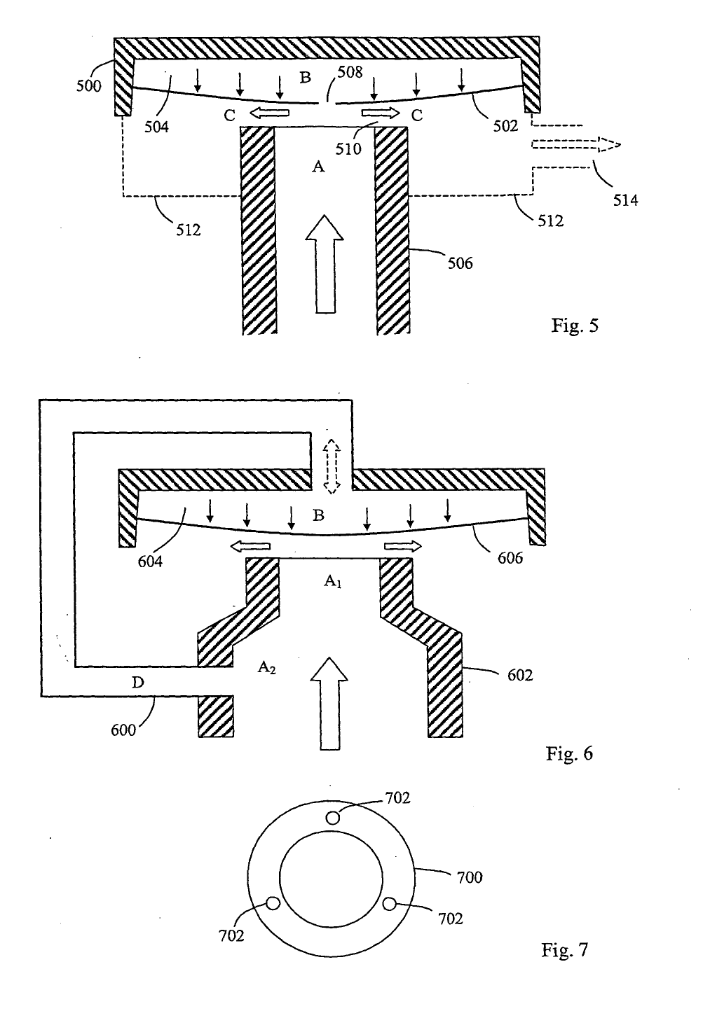

In FIG. 5, a fourth embodiment of the inventive constant flow regulator device is illustrated, which will be used for explaining the basic mechanism of the present invention in more detail below.

A housing 500 and a movable partition made as a resilient diaphragm 502 form an inner compartment 504 arranged in a fixed relationship with an inlet duct 506 for incoming fluid, the diaphragm 502 facing the inlet duct 506. The size of the diaphragm 502 is significantly greater than the size of the inlet duct 506, the latter constituting a high pressure zone when a fluid pressure is applied in the inlet duct 506 that is the sum of a static pressure and a dynamic pressure. The diaphragm 502 has an aperture 508 in the vicinity of the inlet duct 506, providing fluid communication between the incoming fluid and the inner compartment 504. Thereby, a relatively high static fluid pressure at “A” in the inlet duct 506 is basically also present at “B” inside the inner compartment 504 by means of the aperture 508.

The fluid pressure within the inner compartment 504 acts uniformly on the inside of the resilient diaphragm 502, as illustrated by small arrows, i.e. in a direction towards the inlet duct 506. Between the inlet duct 506 and the diaphragm 502, a fluid passage 510 is formed having a cross section area that is changed according to the movements of the diaphragm 502, just as described for the passage 11 in the previous embodiments 1-3. The incoming fluid escapes through the fluid passage 510 and the fluid pressure drops along this passage 510 such that a low pressure zone is formed just after the inlet duct 506, basically at “C” in the figure. Thereby, a relatively low fluid pressure acts on the diaphragm 502 outside the inner compartment 504 in its peripheral area (low pressure zone), as compared to its central area in the vicinity of the inlet duct 506 (high pressure zone).

Due to the greater size of the diaphragm 502 as compared to the inlet duct 506, the resulting force from the fluid pressure on the diaphragm 502 is thus greater on the inside than on the outside, tending to move the diaphragm 502 towards the inlet duct 506 thus reducing the fluid passage 510. However, the fluid pressure force is balanced by the inherent elastic force of the diaphragm 502, which means that the passage 510 can stay open, at least within a certain operation pressure interval. As a result, the fluid passage 510 is reduced when the incoming fluid pressure increases, and vice versa, such that the fluid flow through the device is kept substantially constant when the fluid pressure is changed. The characteristics of the elasticity of the diaphragm 502 can be selected so as to provide an optimal movement thereof within the operating pressure range or interval, e.g. such that its movement is proportional to the square of the pressure change.

As illustrated by dashed lines at 512 in the figure, the housing 500 may be formed in any suitable manner for collecting outgoing fluid, including an outlet opening 514 through which the fluid can be discharged.

In FIG. 6, a fifth embodiment of the inventive constant flow regulator device is illustrated which is different from the fourth embodiment of FIG. 5 by not having the aperture 508 in the diaphragm 502. Instead, a separate fluid connection conduit 600 is arranged between a fluid inlet duct 602 and inner compartment 604, the latter having a movable partition made as a resilient diaphragm 606 with no aperture. The connection conduit 600 may be connected to the inner compartment 604 at any suitable position, since the fluid pressure will be uniform within the inner compartment 604 regardless thereof.

Thus, the fluid pressure in the inlet duct 602 will be present at “D” throughout the fluid connection conduit 600, and also at “B” within the inner compartment 604. The mechanism for moving the resilient diaphragm 606 to obtain a constant fluid flow when the fluid pressure changes, is basically the same as described for the previous embodiments 1-4.

Since no fluid flows through the fluid connection conduit 600 unless the incoming fluid pressure is changed (and then only in quite small amounts of fluid), only a static component of the total pressure in the inlet duct 602 can be present in the conduit 600. Therefore, in this embodiment, the fluid inlet duct 602 is preferably formed with a narrow part close to the movable partition and a wider part farther away from the duct 602 where the entrance to conduit 600 is located. In this way, the dynamic component of the total pressure will be significant in the narrow part at “A₁” in the figure, and less significant in the wide part at “A₂” due to a slower flow speed. Thus, the total pressure will be dominated by the static component at “A₂” such that basically all of the total pressure is conveyed to the inner compartment 604, thereby making the device more responsive to pressure changes.

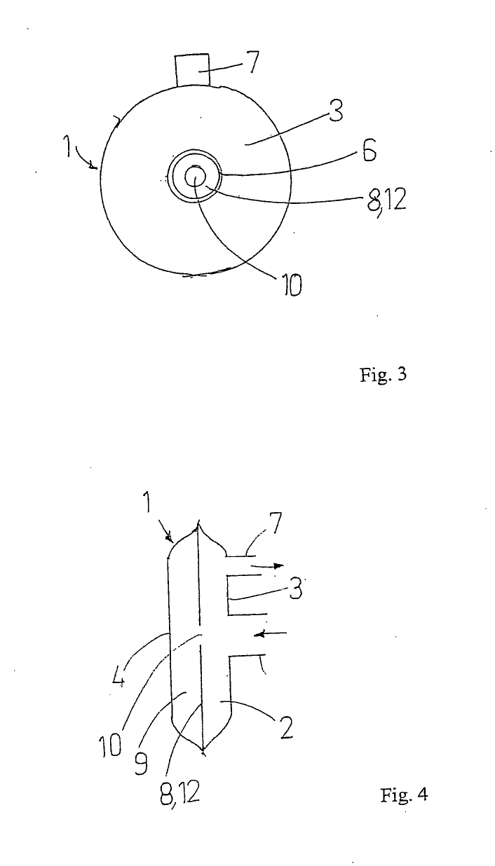

FIG. 7 illustrates a front view of an inlet duct 700 of a constant flow regulator device according to a sixth embodiment, which may be arranged on the end of the inlet duct 506, 602 of FIGS. 5 and 6, or just inside the inlet opening 6 shown in FIGS. 1-4. A plurality of protruding knobs or ribs 702 are arranged on the end surface around the inlet duct or opening facing the movable partition, in order to eliminate the risk of closing the fluid passage 11 or 510 completely if an excessive fluid pressure would move the movable partition into contact with the inlet duct or opening. Moreover, the protruding knobs or ribs 702 may optionally be used to further influence the characteristics of said elastic force, e.g. in combination with the selection of material and/or thickness of resilient part(s) of the movable partition.

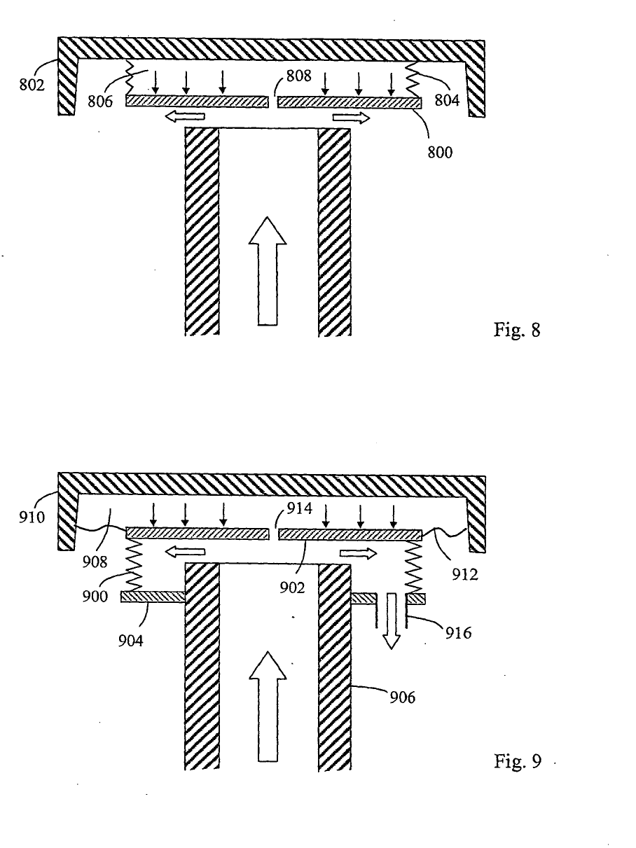

In FIG. 8, a seventh embodiment of the inventive constant flow regulator device is illustrated which is different from the previous embodiments 1-6 by using a rigid movable partition 800 which is connected to a housing 802 by means of an elastic element, here shown as an elastic bellows 804 or the like, which may provide the above-described elastic force that acts on the partition 800. An inner compartment 806 is formed by the partition 800, the housing 802 and the bellows 804. The inner compartment 806 is in fluid communication with an incoming fluid pressure, e.g. by means of an aperture 808 in the partition 800 as shown in this figure, or a fluid connection conduit 600 as shown in FIG. 7. The mechanism for moving the partition 800 to obtain a constant fluid flow when the fluid pressure changes, is basically the same as described for the previous embodiments 1-5. It should be noted that the characteristics of the elasticity of the bellows 804 can be selected so as to provide an optimal movement of the partition 800 within the operating pressure range or interval, as described above.

In FIG. 9, an eighth embodiment of the inventive constant flow regulator device is illustrated which is different from embodiment 7 shown in FIG. 8, by using an elastic bellows 900 or the like arranged between a rigid movable partition 902 and a fixed support plate 904 which can be attached to an inlet duct 906 as shown, or to any other fixed point of support (not shown) . An inner compartment 908 is formed between the partition 902 and a housing 910. An elastic diaphragm 912 may also be used, such that the elastic bellows 900 and the elastic diaphragm 912 together provide the above-described elastic force that acts on the partition 800. The inner compartment 908 is in fluid communication with an incoming fluid pressure, e.g. by means of an aperture 914 in the partition 902. A suitable fluid outlet opening 916 may be arranged in the support plate 904. The mechanism for moving the partition 902 to obtain a constant fluid flow when the fluid pressure changes, is basically the same as described for the previous embodiments 1-7.

The bellows 804 and 900 shown in FIG. 8 and FIG. 9, respectively, may be formed in any suitable manner as long as the above-described elastic force is obtained. It should be noted that also when an elastic bellows and an elastic diaphragm are used in combination as shown in FIG. 9, the characteristics of their elasticity can be selected so as to provide an optimal movement of the partition to create a constant fluid flow within the operating pressure range or interval.

While the invention has been described with reference to specific exemplary embodiments, the description is in general only intended to illustrate the inventive concept and should not be taken as limiting the scope of the invention. It should also be noted that the terms used for describing and defining the present invention, such as “housing”, “inlet duct” and “partition”, can be interpreted broadly.

A person skilled in the art will realise that various suitable modifications and combinations can be made of the shown and described features in the embodiments without departing from the present invention, which is defined by the appended claims.

1. A constant flow regulator device for maintaining a constant flow of fluid when a variable fluid pressure is applied, comprising:
an inlet duct for incoming fluid,
a housing, and
a movable partition facing the inlet duct and, in use,
being subjected to an elastic force, such that a fluid passage of variable cross section area is formed between the inlet duct and the movable partition,
said housing and movable partition forming an inner compartment in fluid communication with the inlet duct for establishing a fluid pressure inside the inner compartment approximately equal to the fluid pressure in the inlet duct,
wherein the size of the movable partition is significantly greater than the size of the inlet duct such that, in use, the partition is moved towards the inlet duct against the elastic force when the fluid pressure in the inlet duct increases to reduce said fluid passage cross section area, and vice versa, thereby maintaining a constant fluid flow.

2. A constant flow regulator device according to claim 1, wherein in use, the characteristics of said elastic force acting on the partition have been selected such that said fluid passage cross section area is changed optimally responsive to changes of said variable fluid pressure, thereby achieving a balance between a force from the inlet pressure plus said elastic force, and a force in the opposite direction from the fluid pressure inside the inner compartment.

3. A constant flow regulator device according to claim 1, wherein a plurality of protruding knobs or ribs are arranged on the end surface around the inlet duct or opening facing the movable partition, to prevent the fluid passage from closing completely if an excessive fluid pressure would move the movable partition into contact with the inlet duct or opening, and optionally to influence the characteristics of said elastic force.

4. A constant flow regulator device according to claim 1, wherein the movable partition is at least partly made as a resilient diaphragm with said elastic force inherent.

5. A constant flow regulator device according to claim 1, wherein said fluid communication between the inner compartment and the inlet duct is obtained by means of an aperture in the movable partition located in the vicinity of the inlet duct.

6. A constant flow regulator device according to claim 1, wherein said fluid communication between the inner compartment and the inlet duct is obtained by means of a separate fluid connection conduit.

7. A constant flow regulator device according to claim 6, wherein the inlet duct is formed with a relatively narrow part close to the movable partition and a wider part farther away from the inlet duct, said separate fluid connection conduit being connected to the inlet duct at the wider part.

8. A constant flow regulator device according to claim 1, wherein the movable partition is made of a rigid material and said elastic force is obtained by means of an elastic bellows acting on the movable partition.

9. A constant flow regulator device according to claim 8, wherein said elastic bellows is arranged between the movable partition and the housing or a fixed support plate attached to the inlet duct.

10. A constant flow regulator device according to claim 1, further comprising at least one outlet opening arranged in said housing outside the inner compartment for discharging the fluid.

11. A device according to claim 10, wherein the cross section area of said at least one outlet opening is significantly larger than said fluid passage cross section area.

12. A constant flow regulator device according to claim 1, said housing comprising at least a first wall a second wall opposite to the first wall, said inlet duct being arranged in the first wall.

13. A method of maintaining a constant flow of fluid when a variable fluid pressure is applied, wherein a housing and a movable partition form an inner compartment in fluid communication with an inlet duct for incoming fluid, and a fluid pressure is established inside the inner compartment approximately equal to the fluid pressure in the inlet duct, said movable partition facing the inlet duct and being subjected to an elastic force such that a fluid passage of variable cross section area is formed between the inlet duct and the movable partition, the size of the movable partition being significantly greater than the size of the inlet duct, wherein the partition is moved towards the inlet duct against the elastic force when the fluid pressure in the inlet duct increases to reduce said fluid passage cross section area, and vice versa, thereby maintaining a constant fluid flow.
